(19) United States
(12) Patent Application Publication
(10) Pub. No.: US 2020/0092767 A1
(43) Pub. Date: Mar. 19, 2020

(54) CONNECTED MODE MOBILITY FOR ENHANCED COVERAGE USER EQUIPMENT

(71) Applicant: Nokia Technologies Oy, Espoo (FI)

(72) Inventors: Jussi-Pekka KOSKINEN, Oulu (FI); Haitao LI, Beijing (CN); Benoist SEBIRE, Tokyo (JP); Yanji ZHANG, Beijing (CN)

(21) Appl. No.: 15/746,894

(22) PCT Filed: Aug. 11, 2015
(86) PCT No.: PCT/CN2015/086659

§ 371 Date: Jan. 23, 2018

(51) Int. Cl. H04W 36/00; H04W 74/00; H04W 74/08; H04W 36/08

(52) U.S. Cl. CPC H04W 36/0072; H04W 74/006; H04W 36/0077; H04W 36/08; H04W 74/004; H04W 74/0833

(57) ABSTRACT

Various communication systems may benefit from proper handling of mobility. In particular, connected mode mobility may be suitably addressed for enhanced coverage user equipment. A method can include determining to attempt access to a target cell in enhanced coverage mode. The method can also include sending, based on the determination, a report to a source cell of an intent to access the target cell in enhanced coverage mode.

### BACKGROUND

### Field

Various communication systems may benefit from proper handling of mobility. In particular, connected mode mobility may be suitably addressed for enhanced coverage user equipment.

### Description of the Related Art

Machine type communication (MTC) also called machine to machine (M2M) communication may utilize coverage enhancements introduced in third generation partnership project (3GPP) Release 13 by the work item on Further LTE Physical Layer Enhancements for MTC, as described in 3GPP document RP-150492, which is hereby incorporated herein by reference in its entirety.

Enhanced Coverage (EC) may affect several aspect of mobility: measurements and handover procedure. In connected mode, the user equipment (UE) and or evolved Node B (eNB) may benefit from knowing how potential target cells are affected by EC. For example, in connected mode such network elements may benefit from knowing whether the UE needs to access the target in EC mode and/or whether EC mode changes between the time the decision to make a handover is taken on the network side and the time the handover is executed by the UE.

### SUMMARY

According to certain embodiments, a method can include determining to attempt access to a target cell in enhanced coverage mode. The method can also include sending, based on the determination, a report to a source cell of an intent to access the target cell in enhanced coverage mode.

In certain embodiments, a method can include determining, by a user equipment, to separate normal coverage reporting from enhanced coverage reporting. The method can also include separating, by the user equipment, normal coverage reporting from enhanced coverage reporting based on the determination.

A method, according to certain embodiments, can include determining a coverage mode from a set including normal coverage mode and at least one enhanced coverage mode. The method can also include identifying that the coverage mode is a change from a current coverage mode. The method can further include indicating the change of the coverage mode to a network.

A method, in certain embodiments, can include receiving, from a user equipment, a report of intent to access a target cell in enhanced coverage mode. The method can also include forwarding to the target cell an indication of the intent to access the target cell in enhanced coverage mode, based on the received report.

According to certain embodiments, a method can include receiving, from a user equipment, normal coverage reporting separated from enhanced coverage reporting. The method can also include processing the separated reporting.

In certain embodiments, a method can include receiving, from a user equipment, an indication of change in coverage mode, wherein the change comprises a change to or from at least one enhanced coverage mode. The method can also include updating resources for the user equipment based on the indication. Alternatively, or in addition, the method can include using the indication to keep a coverage enhancement level synchronized between the user equipment and an access node.

An apparatus, according to certain embodiments, can include at least one processor and at least one memory including computer program code. The at least one memory and the computer program code can be configured to, with the at least one processor, cause the apparatus at least to perform any of the preceding methods.

An apparatus, in certain embodiments, can include means for performing any of the preceding methods.

According to certain embodiments, a method can include initiating a handover at a user equipment from a source access node to a target access node. The method can also include determining, by a user equipment, a coverage mode. The coverage mode can be a normal coverage mode or an enhanced coverage mode. The method can additionally include sending one of a contention-based random access channel preamble and a dedicated preamble to the target access node contingent on the coverage mode.

In certain embodiments, an apparatus can include at least one processor and at least one memory including computer program code. The at least one memory and the computer program code can be configured, with the at least one processor, cause the apparatus at least to initiate a handover at a user equipment from a source access node to a target access node. The at least one memory and the computer program code can also be configured, with the at least one processor, cause the apparatus at least to determine, by a user equipment, a coverage mode. The coverage mode can be a normal coverage mode or an enhanced coverage mode. The at least one memory and the computer program code can additionally be configured, with the at least one processor, cause the apparatus at least to send one of a contention-based random access channel preamble and a dedicated preamble to the target access node contingent on the coverage mode.

An apparatus, according to certain embodiments, means for initiating a handover at a user equipment from a source access node to a target access node. The apparatus can also include means for determining, by a user equipment, a coverage mode. The coverage mode can be a normal coverage mode or an enhanced coverage mode. The apparatus can additionally include means for sending one of a contention-based random access channel preamble and a dedicated preamble to the target access node contingent on the coverage mode.

According to certain embodiments, a computer program product can encode instructions for performing a process. The process can be any of the preceding methods.

In certain embodiments, a non-transitory computer-readable medium can be encoded with instructions that, when executed in hardware, perform a process. The process can be any of the preceding methods.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates another method according to certain embodiments.

FIG. 3 illustrates a further method according to certain embodiments.

FIG. 4 illustrates possible multiple levels of enhanced coverage together with normal coverage.

FIG. 5 illustrates a system according to certain embodiments.

FIG. 6 illustrates an additional method according to certain embodiments.

### DETAILED DESCRIPTION

Certain embodiments may efficiently tackle the possibility of a user equipment (UE) making a handover to a cell in enhanced coverage (EC) mode. In particular, certain embodiments may address various aspects of measurement reporting.

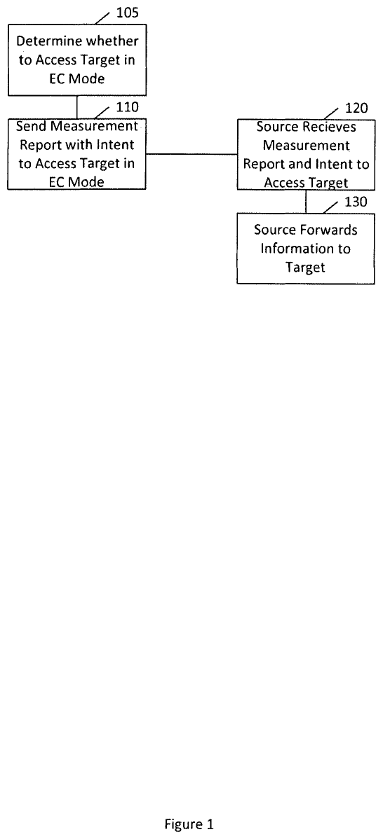

FIG. 1 illustrates a method according to certain embodiments. As shown in FIG. 1, at 110, a UE can report, for example together with a measurement report, whether the UE intends to access the target in EC mode. This intent to access the target in EC mode can be sent separately from such measurement report, if desired. The intent to access the target in EC mode can be based on a previous determination, at 105, to access the target in EC mode.

The source can receive, at 120, the indication of intent to access the target in EC mode. This indication can specifically be forwarded, at 130, to the target evolved Node B (eNB), for example, during handover preparation.

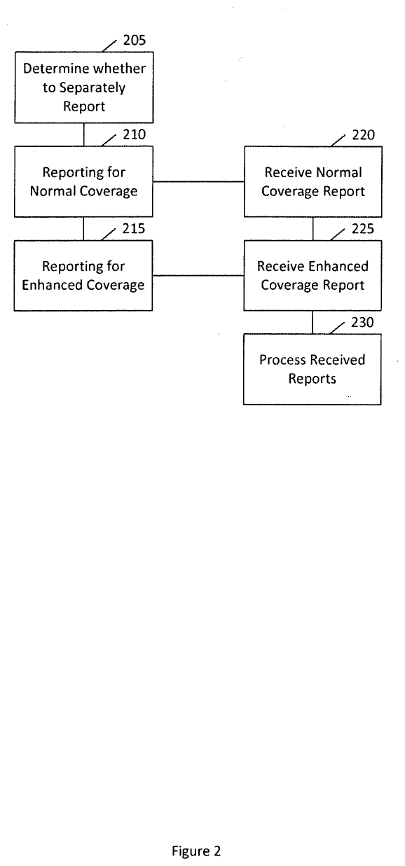

FIG. 2 illustrates another method according to certain embodiments. As shown in FIG. 2, the reporting of measurement information may be separated. For example, there may be separate reporting or reporting events for normal coverage at 210 and for enhanced coverage at 215. This separate reporting may be based on a previous determination, at 205, to separately report for normal coverage and enhanced coverage. At 220, the normal coverage report may be received, and at 225, the enhanced coverage report may be separately received. The reporting can then, at 230, be processed by, for example, a receiving eNB.

For example, in certain embodiments, normal coverage cells can be prioritized over enhanced coverage cells. For example, UE in enhanced coverage can trigger measurement report when a suitable normal coverage cell is found from the configured frequency(s).

In certain embodiments, this prioritization may be applicable only when the UE is in enhanced coverage. In such cases, in normal coverage the UE can follow legacy behavior for measurement reporting.

In any of the above embodiments, or in other embodiments, the involved systems may use coverage mode specific offset/hysteresis parameters to legacy and/or new measurement reporting events. These may be specific in that they can be, for example, individual for each coverage extension level.

Examples of the specific offset or hysteresis parameters can include the following: cell specific offset of a neighbor cell; frequency specific offset of the frequency of the neighbor cell; or any combination thereof. The offset values may be expressed in, for example, dBm or dB.

In certain embodiments there can be new measurement criteria for EC. The new measurement criteria can be, for example, a new event or a new threshold. When the UE detects that a better EC capable cell satisfies the EC criteria, the UE can trigger a measurement report including the measurement results.

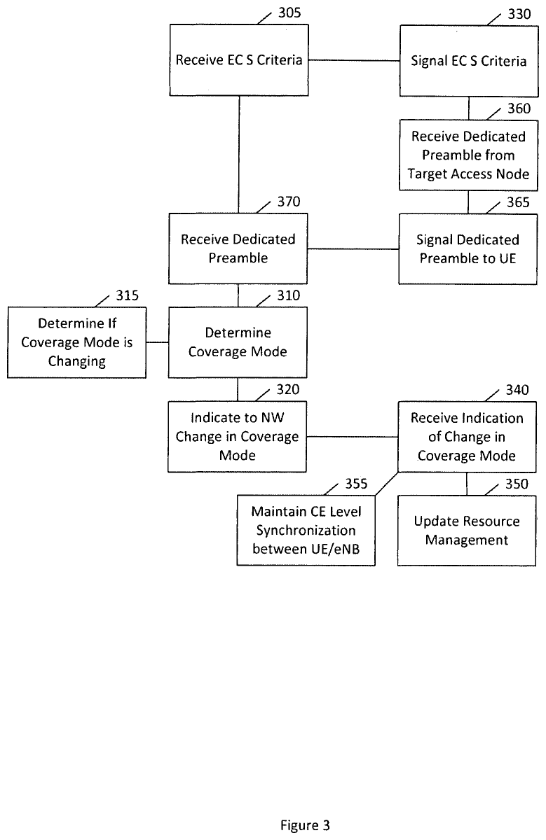

FIG. 3 illustrates a further method according to certain embodiments. As shown in FIG. 3, certain embodiments may address possible EC mode change between the time the decision to make a handover is taken on the network side and the time the handover is executed by the UE. For example, in certain embodiments a UE can, at 310, determine the coverage mode, such as normal coverage or enhanced coverage. This determination can be based on the S criteria and new EC S criteria, which can be signaled at 330 in the system information and received at 305.

The UE can, at 315, determine whether this coverage mode is to be changed from a previous state. Then, at 320 the UE can indicate to the network (NW) when the coverage mode is changed, based on such new criteria. This may be an indication of change from normal coverage (NC) to enhanced coverage or vice versa. In cases where there are multiple enhanced coverage levels, the UE may also indicate a change in EC level as a change in coverage mode.

At 340, the network may receive the indication of change in coverage mode. Then, at 350, the network may update resource management based on the indication of the change in coverage mode. Alternatively, or in addition, the method can include, at 355, using the indication to keep a coverage enhancement level synchronized between the user equipment and an access node, such as an eNB.

For example, separate physical random access channel (PRACH) resource can be assigned for EC UEs. Thus, different preamble pools may be configured for EC UEs and NC UEs separately. If the Handover Command, such as RRC ConnectionReconfiguration including the mobilityControllnfo described in 3GPP TS 36.331, includes dedicate preamble to be used in EC mode, and if the UE knows that the EC mode has changed since last indicated to the source eNB, the UE can avoid using the dedicate preamble but can instead initiate a contention based random access procedure by randomly selecting a preamble that matches its current CE level from the EC UE specific preamble pool. 3GPP TS 36.331 is hereby incorporated herein by reference in its entirety.

There can be various implementations of certain embodiments. Moreover, these various implementations may have a variety of benefits or advantages. For example, certain embodiments may permit for efficient mobility in EC mode. Furthermore, in certain embodiments, measurement reporting and handover procedures can be optimized for EC mode. Likewise, in certain embodiments, the network can be made aware of the UEs' coverage mode(s) and may be able to schedule the UEs accordingly.

As mentioned above, in a handover (HO) procedure, the handover command, such as RRC ConnectionReconfiguration including the mobilityControllnfo as described in 3GPP TS 36.331, may include a dedicated preamble to be used in EC mode. This dedicated preamble can be allocated for the coverage mode that the source/target eNB identified/was informed of. The allocation can be performed by the target eNB, but can be signaled to UE by the source eNB at 365 after being received from the target eNB at 360. The preamble can be identified, after being received by the UE at 370, as being a preamble to be used by the UE with the target eNB.

The UE may know that the EC level has changed since last indicated to the source eNB, but the source/target eNB may not know. At this time, UE has not established a connection with the target eNB. Thus, the UE can initiate contention based random access channel (RACH) to the target eNB even if a dedicated preamble was allocated from target eNB. One benefit may be to let the target eNB know the coverage mode change by using the right RACH resources that match the current EC level.

Certain embodiments may be applicable to the general case of EC mode change, which could be from normal coverage (NC) to enhanced coverage (EC), from EC to NC, or from one EC level to another EC level.

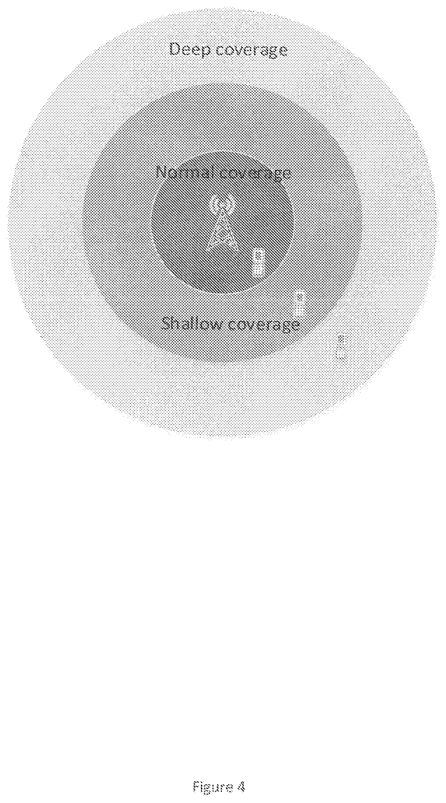

FIG. 4 illustrates possible multiple levels of enhanced coverage together with normal coverage. As shown in FIG. 4, there can be relatively short range of normal coverage, with two levels of enhanced coverage beyond the normal coverage. In this case, those additional levels are respectively designated shallow coverage and deep coverage.

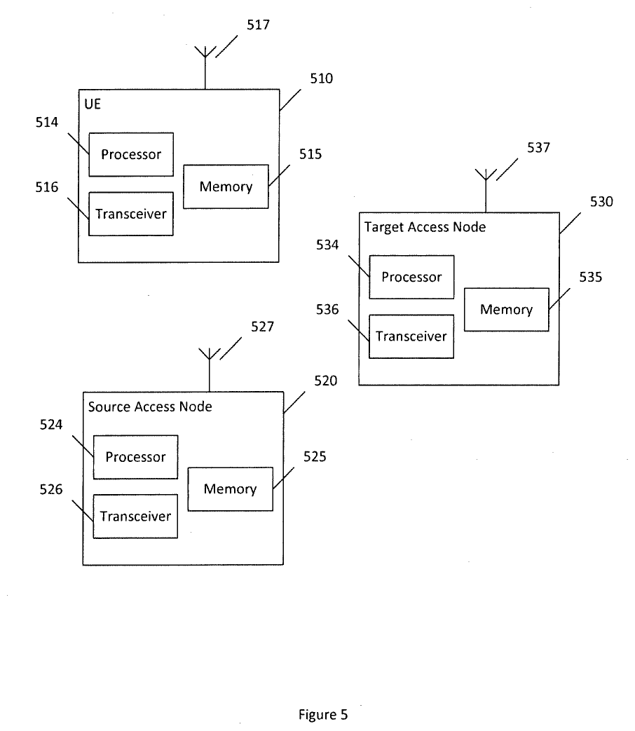

FIG. 5 illustrates a system according to certain embodiments of the invention. In one embodiment, a system may include multiple devices, such as, for example, at least one UE 510, at least one source access node 520, which may be an eNB, or other base station or access point, and at least one target access node 530, which may likewise be an eNB, or other base station or access point.

Each of these devices may include at least one processor, respectively indicated as 514, 524, and 534. At least one memory can be provided in each device, and indicated as 515, 525, and 535, respectively. The memory may include computer program instructions or computer code contained therein. The processors 514, 524, and 534 and memories 515, 525, and 535, or a subset thereof, can be configured to provide means corresponding to the various blocks of FIGS. 1 through 3 or 6.

As shown in FIG. 5, transceivers 516, 526, and 536 can be provided, and each device may also include an antenna, respectively illustrated as 517, 527, and 537. Other configurations of these devices, for example, may be provided. For example, target access node 530 may be configured for wired communication, in addition to wireless communication, and in such a case antenna 537 can illustrate any form of communication hardware, without requiring a conventional antenna.

Transceivers 516, 526, and 536 can each, independently, be a transmitter, a receiver, or both a transmitter and a receiver, or a unit or device that is configured both for transmission and reception.

Processors 514, 524, and 534 can be embodied by any computational or data processing device, such as a central processing unit (CPU), application specific integrated circuit (ASIC), or comparable device. The processors can be implemented as a single controller, or a plurality of controllers or processors.

Memories 515, 525, and 535 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 510, source access node 520, and target access node 530, to perform any of the processes described herein (see, for example, FIGS. 1 through 3 or 6). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 5 illustrates a system including a UE, source access node, and target access node, embodiments of the invention may be applicable to other configurations, and configurations involving additional elements. For example, not shown, additional UEs may be present, and additional access network and core network elements may be present.

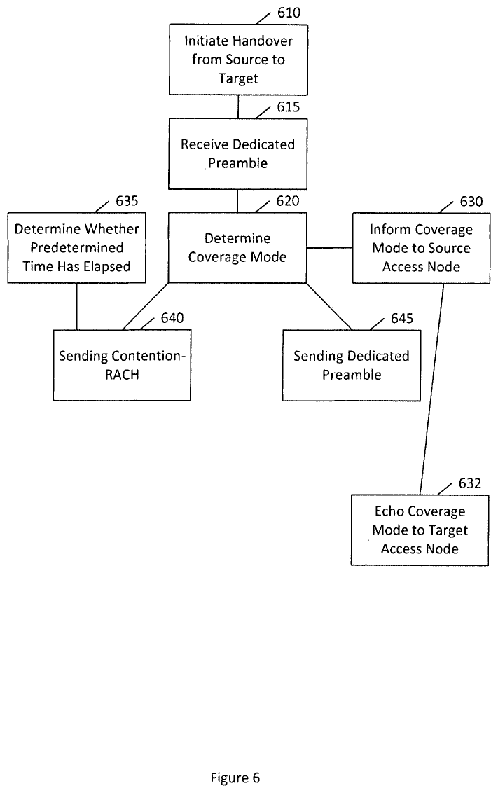

FIG. 6 illustrates an additional method according to certain embodiments. The method can include, at 610, initiating a handover at a user equipment from a source access node to a target access node. The source access node or the target access node comprises at least one of an evolved Node B, a base station, or an access point.

The method can also include, at 615, receiving, by the user equipment, a dedicated preamble in a handover command, wherein the dedicated preamble is allocated by the target access node for a coverage mode that the target access node was informed of.

The method can also include, at 620, determining, by a user equipment, a coverage mode. The coverage mode can be a normal coverage mode or an enhanced coverage mode. The method can further include sending one of a contention-based random access channel preamble or a dedicated preamble to the target access node contingent on the coverage mode.

The sending can include, at 640, sending the contention-based random access channel preamble to the target access node if not informed of the coverage mode to the source access node or if the coverage mode differs from what was previously informed to the source access node. The contention-based random access channel preamble can be selected from the coverage enhancement mode specific preamble pool. Alternatively, the sending can include, at 645, sending the dedicated preamble in accordance with the coverage mode to the target access node if informed and the coverage mode remains unchanged from what was previously informed to the source access node.

The method can additionally include, at 630, informing the coverage mode from the user equipment to the source access node. The coverage mode of the user equipment can be echoed from the source access node to the target access node at 632.

The sending the contention-based random access channel preamble can be further contingent on a predetermined time period not having expired. Thus, the method may also include, at 635, determining whether a predetermined time period has elapsed. In an example embodiment, the user equipment uses random access to inform the source access node of the coverage mode. Random access reattempt is defined by whether the user equipment does not receive random access response (RAR) in a certain time window. The predetermined time period can be the period of the time window. The predetermined time period can be used by the user equipment to determine whether the source access node has received the coverage mode after the user equipment sent out the coverage mode to the source access node. In another example embodiment, the predetermined time period may take whether the target access node has received the coverage mode from the source access node into account.

Sending the contention-based random access channel preamble can include randomly selecting a preamble that matches the current coverage enhancement level from a user equipment specific preamble pool.

The current coverage mode can be determined based at least in part on one of a S criteria and a EC S criteria.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS

CE Coverage enhancement

EC Enhanced Coverage

MTC Machine Type Communication

M2M Machine To Machine

NC Normal Coverage

NW Network

RA Random Access

RLF Radio Link Failure

UE User Equipment

1-20. (canceled)

21. A method, comprising:
initiating a handover at a user equipment from a source access node to a target access node;
determining, by the user equipment, a coverage mode, wherein the coverage mode comprises a normal coverage mode or an enhanced coverage mode; and
sending one of a contention-based random access channel preamble and a dedicated preamble to the target access node contingent on the coverage mode.

22. The method according to claim 21, further comprising:
informing the coverage mode from the user equipment to the source access node.

23. The method according to claim 22, wherein the coverage mode of the user equipment is echoed from the source access node to the target access node.

24. The method according to claim 21, wherein the sending comprises sending the contention-based random access channel preamble to the target access node if not informed of the coverage mode to the source access node or if the coverage mode differs from what was previously informed to the source access node; or
sending the dedicated preamble in accordance with the coverage mode to the target access node if informed and the coverage mode remains unchanged from what was previously informed to the source access node.

25. The method according to claim 21, further comprising:
receiving, by the user equipment, the dedicated preamble in a handover command, wherein the dedicated preamble is allocated by the target access node for the coverage mode that the target access node was informed of.

26. The method according to claim 21, wherein at least one of the source access node or the target access node comprises at least one of an evolved Node B, a base station, or an access point.

27. The method according to claim 21, wherein the sending the contention-based random access channel preamble is further contingent on a predetermined time period not having expired.

28. The method according to claim 21, wherein the sending the contention-based random access channel preamble comprises randomly selecting a preamble that matches the current coverage enhancement level from a user equipment specific preamble pool.

29. The method according to claim 21, wherein the coverage mode is determined based at least in part on one of a S criteria and a EC S criteria.

30. An apparatus, comprising:
at least one processor; and
at least one memory including computer program code,
wherein the at least one memory and the computer program code are configured, with the at least one processor, cause the apparatus at least to
initiate a handover at a user equipment from a source access node to a target access node;
determine, by the user equipment, a coverage mode, wherein the coverage mode comprises a normal coverage mode or an enhanced coverage mode; and
send one of a contention-based random access channel preamble and a dedicated preamble to the target access node contingent on the coverage mode.

31. The apparatus according to claim 30, wherein the at least one memory and the computer program code are configured, with the at least one processor, cause the apparatus at least to inform the coverage mode from the user equipment to the source access node.

32. The apparatus according to claim 31, wherein the coverage mode of the user equipment is echoed from the source access node to the target access node.

33. The apparatus according to claim 30, wherein the at least one memory and the computer program code are configured, with the at least one processor, cause the apparatus at least to
send the contention-based random access channel preamble to the target access node if not informed of the coverage mode to the source access node or if the coverage mode differs from what was previously informed to the source access node; or
send the dedicated preamble in accordance with the coverage mode to the target access node if informed and the coverage mode remains unchanged from what was previously informed to the source access node.

34. The apparatus according to claim 30, wherein the at least one memory and the computer program code are configured, with the at least one processor, cause the apparatus at least to:
receive, by the user equipment, the dedicated preamble in a handover command, wherein the dedicated preamble is allocated by the target access node for the coverage mode that the target access node was informed of.

35. The apparatus according to claim 30, wherein at least one of the source access node or the target access node comprises at least one of an evolved Node B, a base station, or an access point.

36. The apparatus according to claim 30, wherein sending the contention-based random access channel preamble is further contingent on a predetermined time period not having expired.

37. The apparatus according to claim 30, wherein the at least one memory and the computer program code are configured, with the at least one processor, cause the apparatus at least to send the contention-based random access channel preamble by at least randomly selecting a preamble that matches the current coverage enhancement level from a user equipment specific preamble pool.

38. The apparatus according to claim 30, wherein the coverage mode is determined based at least in part on one of a S criteria and a EC S criteria.

39. A computer program product comprising a computer-readable medium bearing computer program code embodied therein for use with a computer, the computer program code comprising:
code for initiating a handover at a user equipment from a source access node to a target access node;
code for determining, by a user equipment, a coverage mode, wherein the coverage mode comprises a normal coverage mode or an enhanced coverage mode; and
code for sending one of a contention-based random access channel preamble and a dedicated preamble to the target access node contingent on the coverage mode.

40. The computer program product according to claim 39, wherein sending the contention-based random access channel preamble is further contingent on a predetermined time period not having expired.
